(19) United States
(12) Patent Application Publication
(10) Pub. No.: US 2014/0133413 A1
(43) Pub. Date: May 15, 2014

(54) METHOD AND APPARATUS FOR DESIGNING SIGNALS TO MITIGATE SUBCARRIER INTERFERENCE

(71) Applicant: ELECTRONICS AND TELECOMMUNICATIONS RESEARCH INSTITUTE, DAEJEON (KR)

(72) Inventors: Jihyung KIM, Daejeon (KR); Jung Hyun KIM, Daejeon (KR); Hyun-jae KIM, Incheon (KR); Kwang Jae LIM, Daejeon (KR)

(73) Assignee: ELECTRONICS AND TELECOMMUNICATIONS RESEARCH INSTITUTE, DAEJEON (KR)

(21) Appl. No.: 14/075,428

(22) Filed: Nov. 8, 2013

(30) Foreign Application Priority Data
Nov. 9, 2012 (KR) 10-2012-0127027

(51) Int. Cl. H04W 72/08

(52) U.S. Cl. CPC H04W 72/082
USPC 370/329

(57) ABSTRACT

In order to reduce interference that may be generated when a plurality of signals having different subcarrier intervals are received, a method of controlling a signal having a larger subcarrier interval to be suitable for a signal having a smaller subcarrier interval and a method of removing CFO interference are provided. Subcarrier intervals of a plurality of signals to be transmitted by wireless terminals are compared with each other, and signals are designed so that a signal having the largest subcarrier interval may be repeatedly transmitted. Therefore, interference that may be generated among different kinds of signals when the base station simultaneously receives the different kinds of signals to perform Fourier transform may be mitigated. In addition, interference caused by a CFO may be removed by previously compensating the CFO estimated in a time domain to perform Fourier transform.

### CROSS-REFERENCE TO RELATED APPLICATION

This application claims priority to and the benefit of Korean Patent Application No. 10-2012-0127027 filed in the Korean Intellectual Property Office on Nov. 9, 2012, the entire contents of which are incorporated herein by reference.

### BACKGROUND OF THE INVENTION

(a) Field of the Invention

The present invention relates to a method of reducing interference between subcarriers in a multi-carrier system.

(b) Description of the Related Art

A base station receives various signals such as a data signal and a ranging signal from a plurality of terminals. When subcarrier intervals of the data signal and the ranging signal received by the base station are Δf and Δf/2 and fast Fourier transforms (FFT) of the signals are different from each other, interference may be generated between the subcarriers of the data signal and the ranging signal. For example, when the data signal performs FFT having a magnitude of K, the simultaneously received ranging signal performs FFT having a magnitude of 2K so that interference may be generated between the subcarriers of the data signal and the ranging signal.

In addition, when the plurality of signals received by the base station include different carrier frequency offsets (hereinafter referred to as “CFO”), interference may be generated between the subcarriers of the data signal and the ranging signal.

### SUMMARY OF THE INVENTION

According to an exemplary embodiment of the present invention, in order to reduce interference that may be generated when a plurality of signals having different subcarrier intervals are received, a method of controlling a signal having a larger subcarrier interval to be suitable for a signal having a smaller subcarrier interval and a method of removing CFO interference are provided.

According to an aspect of the present invention, a method of transmitting signals from wireless terminals to a base station is provided. The method includes comparing intervals of subcarriers allotted to a plurality of signals to which different frequency bands are allotted with each other to determine a number of repeated transmissions with respect to a first signal among the plurality of signals, and repeatedly transmitting the first signal to the base station in accordance with the number of repeated transmissions.

The comparing the intervals of the subcarriers may include calculating a ratio of a first subcarrier interval of the first signal to a second subcarrier interval of a second signal among the plurality of signals.

The determining the number of repeated transmissions may include determining a reciprocal of the ratio as the number of repeated transmissions.

When the first signal is a ranging signal, considering maximum round trip delay (RTD) of the ranging signal to design signals so that a second signal is not transmitted in the maximum RTD may be further included.

When the subcarrier interval of the first signal is larger than that of the second signal, the repeatedly transmitting the first signal may include transmitting the repeated first signal while the second signal is transmitted.

According to another aspect of the present invention, an apparatus included in a terminal to transmit signals to a base station is provided. The signal transmitting apparatus includes a repetition determining unit for comparing intervals of subcarriers allotted to a plurality of signals to which different frequency bands are allotted with each other to determine a number of repeated transmissions with respect to a first signal among the plurality of signals, and a transmitting unit for repeatedly transmitting the first signal to the base station in accordance with the number of repeated transmissions.

The repetition determining unit may calculate a ratio of a first subcarrier interval of the first signal to a second subcarrier interval of a second signal among the plurality of signals to compare the intervals of the subcarriers with each other.

The repetition determining unit may determine a reciprocal of the ratio as the number of repeated transmissions.

The signal transmitting apparatus may further include a signal delay unit for considering maximum RTD of the ranging signal to design signals so that a second signal is not transmitted in the maximum RTD when the first signal is a ranging signal.

When the subcarrier interval of the first signal is larger than that of the second signal, the transmitting unit may transmit the repeated first signal while the second signal is transmitted.

According to another aspect of the present invention, a method of removing CFO interference of signals that a base station receives from wireless terminals is provided. The CFO interference removing method may include a first signal among the received signals estimating a CFO of the first signal, the received signal compensating the CFO, performing fast Fourier transform (FFT) on the compensated signal, removing a band of the first signal from the second signal on which the FFT is performed, performing inverse FFT (IFFT) on the second signal, and re-compensating the CFO in a third signal on which the IFFT is performed.

Estimating the CFO may be performed in a time domain where the signals are received.

### BRIEF DESCRIPTION OF THE DRAWINGS

FIG. 1 is a view illustrating a network in which a base station according to an exemplary embodiment of the present invention receives different kinds of signals from a plurality of terminals.

FIG. 2 is a view illustrating structures of signals transmitted to a base station according to an exemplary embodiment of the present invention.

FIG. 3 is a view illustrating a frame including a plurality of symbols according to an exemplary embodiment of the present invention.

FIG. 4 is a flowchart illustrating a method of removing CFO interference according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In the entire specification, a terminal may refer to a mobile terminal (MT), a mobile station (MS), a subscriber station (SS), a portable subscriber station (PSS), an access terminal (AT), and user equipment (UE), and may include entire or partial functions of the MT, the MS, the SS, the PSS, the AT, and the

UE.

In addition, a base station (BS) may refer to a node B, an evolved node B (eNodeB), an access point (AP), a radio access station (RAS), a base transceiver station (BTS), and a mobile multihop relay (MMR)-BS, and may include entire or partial functions of the node B, the eNodeB, the AP, the RAS, the BTS, and the MMR-BS.

In the entire specification, unless explicitly described to the contrary, the word “comprise” and variations such as “comprises” or “comprising” will be understood to imply the inclusion of stated elements but not the exclusion of any other elements. In addition, each of the terms “. . . unit”, “. . . er”, “module”, and “block” specified in the specification means a unit that processes at least one function or operation, which may be realized by hardware or software or a combination of hardware and software.

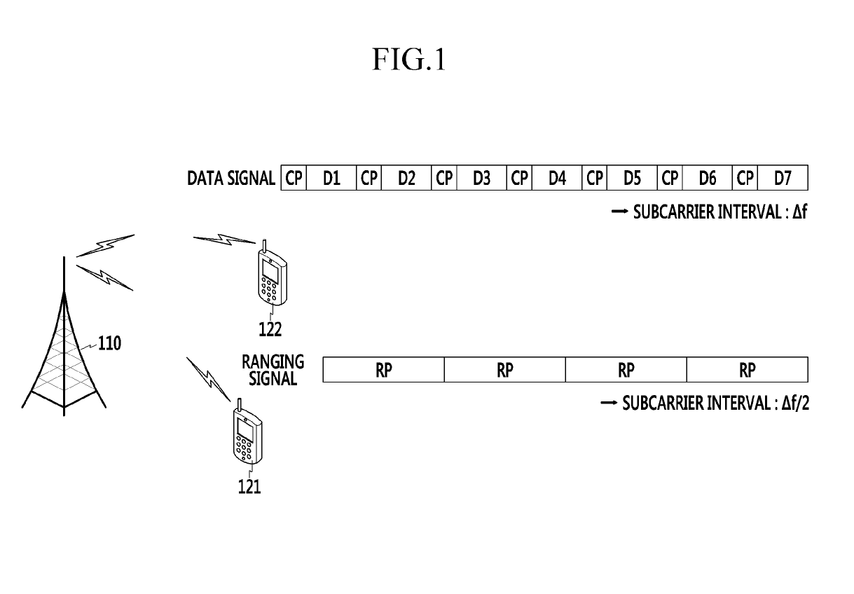

FIG. 1 is a view illustrating a network in which a base station according to an exemplary embodiment of the present invention receives different kinds of signals from a plurality of terminals.

Referring to FIG. 1, a first terminal 121 transmits a ranging signal to a base station 110 and a second terminal 122 transmits a data signal to the base station 110.

According to the exemplary embodiment of the present invention, a case in which a subcarrier interval of the ranging signal transmitted by the first terminal 121 is half (Δf/2) of that Δf of the data signal transmitted by the second terminal 122 is illustrated. At this time, it is assumed that the ranging signal transmitted by the first terminal 121 and the data signal transmitted by the second terminal 122 use different frequency bands.

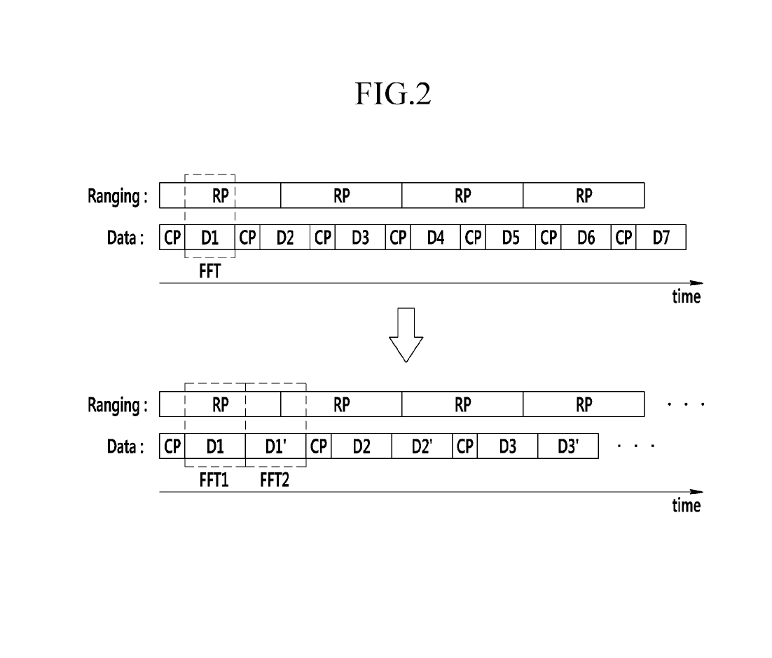

FIG. 2 is a view illustrating structures of signals transmitted to a base station according to an exemplary embodiment of the present invention.

Referring to FIG. 2, since a subcarrier interval of a data signal is larger than that of a ranging signal, a magnitude of FFT in a time axis of the ranging signal is larger than that of the data signal. That is, according to the exemplary embodiment of the present invention, when the subcarrier interval of the data signal is twice that of the ranging signal according to an exemplary embodiment of the present invention, the magnitude of the FFT of the data signals may be K and that of the ranging signal may be 2K.

Referring to an upper part of FIG. 2, when the base station that simultaneously receives the data signal and the ranging signal performs the FFT having the magnitude of K in order to restore the data signal corresponding to a region D1, interference may be generated by the ranging signal whose FFT has the magnitude of 2K. In addition, when the FFT whose magnitude is 2K is performed for ranging, interference may be generated by the data signal whose FFT has the magnitude of K.

According to the exemplary embodiment of the present invention, in order to solve such a problem, signals may be formed so that a signal having a larger subcarrier interval is suitable for a signal having a smaller subcarrier interval as illustrated in a lower part of FIG. 2.

Referring to the lower part of FIG. 2, since the subcarrier interval of the ranging signal is twice that of the data signal, the data signal is repeatedly transmitted twice between cyclic prefixes (CP).

In this case, the base station continuously performs FFT twice (FFT1 and FFT2) in order to restore the data signal. For example, when a sample index of a ranging preamble (RP) included in the ranging signal is k (k=1, 2, . . . , 2K), indices of the RP are m to m+K−1 when the FFT1 is performed and indices of the RP are m+K to 2K and 1 to m−1 when the FFT2 is performed. The indices of the FFT1 and those of the FFT2 may be exchanged.

At this time, interference may be generated twice by the ranging signal. That is, the interference generated by the ranging signal may be a when the FFT1 is performed with respect to the data signal D1, and may be −α when the FFT2 is performed with respect to the data signal D1′. Therefore, the data signal is repeatedly transmitted twice in accordance with the subcarrier interval of the ranging signal between the CPs so that the interference generated by the ranging signal may be offset (i.e., α+(−α)=0).

In addition, when the subcarrier interval of the ranging signal is ¼ of that of the data signal, the data signal may be repeatedly transmitted four times between the CPs. For example, when an RP sample index is k in the time axis, indices of an RP corresponding to FFT1 are m to m+K−1, indices of an RP corresponding to FFT2 are m+K to m+2K−1, indices of an RP corresponding to FFT3 are m+2K to m+3K−1, and indices of an RP corresponding to FFT4 are 1 to m−1 and m+3K to 4K. The corresponding indices of the FFT1, the FFT2, the FFT3, and the FFT4 may be exchanged.

The interference generated by the ranging signal of four times may be added to the interference generated when the FFT1 to FFT4 are performed so that net interference may be offset.

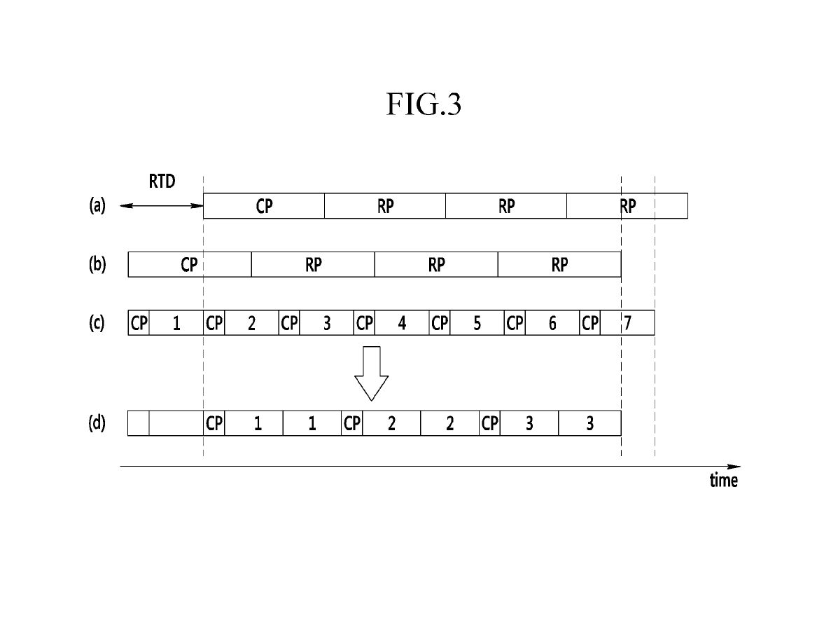

FIG. 3 is a view illustrating a frame including a plurality of symbols according to an exemplary embodiment of the present invention.

Referring to FIG. 3, a signal (a) and a signal (b) represent ranging signals. The base station receives the signal (a) with round trip delay (RTD). The RTD illustrated in the signal (a) is the maximum value of delay that may be allowed without interference. The signal (b) is obtained when the RTD is 0.

A signal (c) is a data signal of the standard IEEE 802.16m received by the base station. In a case where the ranging signal is received by the base station with the RTD (the signal (a)), when the data signal exists in the RTD region of the signal (a) (the signal (c)), interference may be generated in the data signal by the ranging signal in a frequency band. Therefore, it is necessary to design the signals so that the data signal does not exist in the RTD region of the signal (a) and the entire data signal is included in the entire section of the ranging signal.

A signal (d) is obtained by changing an arrangement of data sections of the signal (c) so that the data sections may be repeatedly transmitted according to the exemplary embodiment of the present invention. Referring to FIG. 3, the signal (d) is designed so that a signal is not included in the RTD and the entire data signal (the signal (d)) is included in the entire section of the ranging signal (the signal (b)) (i.e., (b)>(d)). In the signal (d), the data signal between the CPs is repeated twice.

As described above, according to the exemplary embodiment of the present invention, the subcarrier intervals of the plurality of signals to be transmitted by wireless terminals are compared with each other and the signals are designed so that a signal having the largest subcarrier interval may be repeatedly transmitted. Therefore, interference that may be generated among different kinds of signals may be mitigated when Fourier transform is performed.

On the other hand, the ranging signal and the data signal received by the base station may include different CFOs. At this time, interference among the signals may be generated when the ranging signal and the data signal include different CFOs. According to another exemplary embodiment of the present invention, interference may be removed by comparing a magnitude of the ranging signal in a frequency band with that of the data signal in a frequency band.

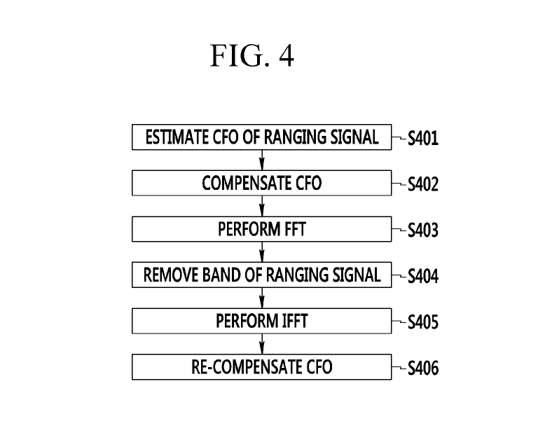

FIG. 4 is a flowchart illustrating a method of removing CFO interference according to an exemplary embodiment of the present invention.

According to an exemplary embodiment of the present invention, referring to FIG. 4, a method of efficiently removing interference caused by CFOs included in a ranging signal and a data signal will be described.

Referring to FIG. 4, a base station that receives the ranging signal and the data signal estimates the CFO of the ranging signal in a time domain (S401). Although the CFO of the ranging signal interferes with the data signal in a frequency domain, estimation of the CFO of the ranging signal in the time domain is not affected.

Then, a CFO of a received signal is compensated based on the estimated CFO of the ranging signal (S402). Since the estimated CFO is the CFO of the ranging signal, when the CFO is compensated, in the received signal, the CFO of the ranging signal is removed.

Then, after FFT is performed on the received signal from which the CFO of the ranging signal is removed (S403) so that the received signal is transformed into a frequency domain, a band of the ranging signal is made 0 by a frequency filter (S404) and inverse FFT (IFFT) is performed (S405). Then, the signal on which the IFFT is performed is re-compensated

(S406) so that interference caused by the CFO of the ranging signal generated in the data signal may be removed.

According to the exemplary embodiment of the present invention, the CFO interference between the ranging signal and the data signal is taken as an example. However, the CFO included in the data signal may be previously estimated so that the interference generated in the ranging signal by the CFO of the data signal may be removed. In addition, CFO interference between two other arbitrary kinds of signals may be removed by the above-described method.

As described above, according to the exemplary embodiment of the present invention, the CFO estimated in the time domain is previously compensated and Fourier transform is performed so that the interference caused by the CFO may be removed.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method of transmitting signals from wireless terminals to a base station, comprising:
comparing intervals of subcarriers allotted to a plurality of signals to which different frequency bands are allotted with each other to determine a number of repeated transmissions with respect to a first signal among the plurality of signals; and
repeatedly transmitting the first signal to the base station in accordance with the number of repeated transmissions.

2. The method of claim 1, wherein
the comparing the intervals of the subcarriers comprises
calculating a ratio of a first subcarrier interval of the first signal to a second subcarrier interval of a second signal among the plurality of signals.

3. The method of claim 2, wherein
The determining the number of repeated transmissions comprises
determining a reciprocal of the ratio as the number of repeated transmissions.

4. The method of claim 2, further comprising,
when the first signal is a ranging signal,
designing the first signal in consideration of maximum round trip delay (RTD) of the ranging signal so that a second signal is not transmitted in the maximum RTD.

5. The method of claim 2, wherein
the repeatedly transmitting the first signal when the subcarrier interval of the first signal is larger than that of the second signal comprises
transmitting the repeated first signal while the second signal is transmitted.

6. An apparatus included in a terminal to transmit signals to a base station, comprising:
a repetition determining unit configured to compare intervals of subcarriers allotted to a plurality of signals to which different frequency bands are allotted with each other to determine a number of repeated transmissions with respect to a first signal among the plurality of signals; and
a transmitting unit configured to repeatedly transmit the first signal to the base station in accordance with the number of repeated transmissions.

7. The apparatus of claim 6, wherein the repetition determining unit calculates a ratio of a first subcarrier interval of the first signal to a second subcarrier interval of a second signal among the plurality of signals to compare the intervals of the subcarriers with each other.

8. The apparatus of claim 7, wherein the repetition determining unit determines a reciprocal of the ratio as the number of repeated transmissions.

9. The apparatus of claim 7, further comprising,
when the first signal is a ranging signal,
a signal delay unit configured to design the first signal in consideration of maximum RTD of the ranging signal so that a second signal is not transmitted in the maximum RTD.

10. The apparatus of claim 7, wherein
when the subcarrier interval of the first signal is larger than that of the second signal,
the transmitting unit transmits the repeated first signal while the second signal is transmitted.

11. A method of removing carrier frequency offset (CFO) interference among signals that a base station receives from wireless terminals, the method comprising:
estimating a CFO of a first signal among the received signals;
compensating the CFO in the received signal;
performing fast Fourier transform (FFT) on the compensated signal;
removing a band of the first signal from a second signal on which the FFT is performed;
performing inverse FFT (IFFT) on the second signal; and
re-compensating the CFO in a third signal on which the IFFT is performed.

12. The apparatus of claim 11, wherein estimating the CFO is performed in a time domain where the signals are received.
